(19) United States
(12) Patent Application Publication
(10) Pub. No.: US 2005/0223906 A1
(43) Pub. Date: Oct. 13, 2005

(54) Stir-frying Apparatus with Overhead Heating Device

(76) Inventors: Zhaoxia Xu, Ypsilanti, MI (US); Zheng Peng, Ypsilanti, MI (US)

Correspondence Address: ZHAOXIA XU, 4694 SYCAMORE DR., YPSILANTI, MI, 48197, US

(21) Appl. No.: 10/709,085

(22) Filed: Apr. 12, 2004

(51) Int. Cl. A23L 1/00

(52) U.S. Cl. 99/348

(57) ABSTRACT

A stir-frying apparatus (100) with an overhead-heating device (128). Apparatus (100) comprises a container (102) for holding foods, a lid (120) covering on top of container (102), a bottom heating device (118) installed underneath container (102) and an overhead heating device installed on lid (120), a stirring blade (136) rotatably and removably installed inside container (102) for stirring foods, a power-drive assembly (140) operationally coupled with blade (136) for driving blade (136) through repeating stirring cycles, a coupling device (134) for coupling assembly (140) and blade (136), a venting device (200) for filtering and deodorizing cooking fumes, a blowing device (202) for forcing fresh air into apparatus (100) for the removal of moisture from therein-side, and an ingredient adding conduit (250) for use of adding ingredients during a frying process.

### BACKGROUND OF INVENTION

This invention generally relates to cooking/food processing apparatuses. More specifically, this invention relates to stir-frying apparatuses with an over-head heating device.

Stir-frying of meats and vegetables without the use of oil or with the use of very little oil has become increasingly popular in recent years as the population has become more health conscious. Frying adds a unique taste to the food product while the use of no cooking oil (or at least very little) minimizes the amount of fat in the diet. By quickly frying vegetable products on a very high temperature heated surface (e.g., 425 degree F. to 600 degree F.) the vegetable product maintains a crisp, fresh texture. This frying process has been used for centuries by Asian population and in recent years has become very popular in Western World.

Chinese stir-frying cooking is the brisk cooking of small cuts of meats and vegetables in hot oil over intense heat, calling for split-second timing and swift movements in an uninterrupted rhythm. Two elements are crucial to stir-frying. Firstly, thorough organization, in the sense that everything needed is within reach, such that no interruption will disturb the cooking once it starts; and secondly, vigilance from the person who must be ready to measure and add ingredients, and adjust timing and volume of heat instantly. Each dish is allowed to cook for only several minutes. This cooking process requires considerable skill in judging the progress of a dish by the smell, look and feel of the food, and the sound of the cooking. Were there a way to capture and multiply the knowledge and the skills of a good Chinese chef, a whole new opportunity would be created for expansion in home food preparation and restaurant industries.

There are some other important issues associated with preparing stir-fried foods, especially cooking at home, which need to be tackled.

First, the contact of moisture-containing raw foods with hot oil produces grease splattering. Most times, the splattering liquids and food particles reach out of frying apparatuses to considerable distances. These will not only mess up stovetops and surrounding surfaces but also create undue oil burn injuries to the people who are preparing fried foods. The problem of grease fires in kitchens as well as severe oil burns to people has been well documented.

Second, oil vapor is produced when oil is heated. The people who are preparing fried foods involuntarily inhale considerable amount of cooking fumes during cooking processes. Oil vapor is harmful to human health and might pose long-term health threats to the people who expose themselves to oil vapor on a very regular base. The oil vapor generated in cooking processes might easily reach much farther in the kitchen or even other rooms and deposit on the furniture, paintings, electrical appliances, etc., causing long-term hazards to home environment.

Third, If the layer of food pieces on the heated surface is more than 2 or 3 inches deep, the portion of the food pieces being heated on the bottom layer gives off steam. This steam rises through the food pieces above, thereby steam cooking them, such that the prepared food becomes limp and soggy. Applying heat only to the bottom can result in the upper portion of food being insufficiently heated. The heat distribution problem cannot be resolved by simply increasing the power output of the bottom-heating element. This is due to the fact that the increased heating output tends to locally overheat the bottom layer of food pieces.

Over years, various devices have been developed to address some of these problems associated with stir-frying.

U.S. patent application Ser. No. 10/604,389, filed by Zhaoxia Xu and Zheng Peng, on Jul. 17, 2003, teaches an automatic frying apparatus for both deep and shallow frying. The frying apparatus comprises a container for holding foods and oil, a lid covering on top of the container, a bottom heating device installed underneath the container, a stirring blade rotatably and removably installed inside the container, on the central bottom, a power-drive assembly operationally coupled with the stirring blade for driving the stirring blade through repeating stirring cycles, a blowing device for forcing fresh air into the frying apparatus for the removal of moisture inside the container, and a venting device for filtering and deodorizing cooking fumes.

One disadvantage associated with this prior art is that it is specifically designed for frying, deep or shallow. It is surely advantageous if its functionality can be extended, for example, extended to cover roasting, baking, etc., such that consumers can buy just one appliance to use for frying, roasting, baking, etc., and such that the benefits of frying and roasting can be combined to heat foods more efficiently and to prepare healthier foods.

U.S. Pat. No. 4,649,810, issued to Wong, on Mar. 17, 1987, illustrates an automatic cooking apparatus having a compartmentalized carousel for various ingredients of a particular dish to be loaded and a stirring blade generally conforming to the shape of the bottom of a cooking vessel. As the blade revolves around a vertical axis, it causes the foods to spread and to roll over the top of the blade.

U.S. Pat. No. 4,779,522, issued to Wong, on Oct. 25, 1988, illustrates an automatic cooking apparatus having a Geneva drive mechanism for intermittently and selectively rotating one or more drive shafts through indexed positions.

U.S. Pat. No. 4,820,054, issued to Wong, on Apr. 11, 1989, illustrates a stirring mechanism, which provides a stirring action having horizontal and vertical rotation.

The proposed designs of the above three prior art products, issued to the same inventor, might be useful for stir-frying, but they are generally too complicated in configuration and are too difficult to clean after use. In additions, they failed to address the need of optimizing heating systems, the issues of cooking fume hazards to users and their home environment, and the issue of the upper layers of food pieces being steam cooked. These are among many other reasons why these prior art products are not appealing to the market and general public.

While other automatic food preparation apparatuses have been introduced in the past, and some were specially designed for cooking Chinese dishes, various problems and drawbacks have hindered their commercial viability and success.

Electrical frying apparatuses are popular home appliances nowadays. However, these oil fryers have been known to cook their baskets' foods unevenly. Additionally, many fried items retain too much oil and, when removed from the fryer, remain greasy and generally unwholesome. Moreover, such appliances require large quantities of frying oil, long frying times, and large quantities of energy for heating the frying oil.

Therefore, it remains desirable to provide stir-frying apparatuses that can be used to combine the benefits of frying, roasting, and baking, etc.; that can reduce the time required for proper cooking; that are automatic to minimize the human involvement or chore during the frying process, that favors homogeneous heating of foods, that require minimal quantity of oil for frying foods, that can effectively and efficiently remove the surface moisture content of food pieces to achieve the characteristic of low fat absorption and great looking, taste, and texture of foods, that are inexpensive to manufacture and simple and easy to use, and also that are people and home environment friendly.

### SUMMARY OF INVENTION

Accordingly, the present invention is a stir-frying apparatus with an overhead-heating device. This stir-frying apparatus comprises a container having an open top for holding foods, a lid covering on top of the container for closing up the open top, a bottom heating device installed underneath the container for heating foods from below and an overhead heating device installed at an upper position of the apparatus for heating foods from above, a stirring blade rotatably and removably installed inside the container, on the central bottom, a power-drive assembly operationally coupled with the stirring blade for driving the stirring blade through repeating stirring cycles, a blowing device for forcing fresh air into the apparatus for the removal of moisture inside the container, a venting device for filtering and deodorizing cooking fumes, and a ingredient adding conduit to be used for adding various ingredients during a frying process.

The stirring blade sweeps across food pieces in an intermittent operation, in which it dwells for a predetermined dwell period near the end of each stirring cycle. This intermittent operation affords relief from constant stirring of food pieces at a higher speed, thereby favoring foods of great texture and looking.

Cooking fumes are treated right before leaving the apparatus, whereby this stir-frying apparatus of the present invention is people and home environment friendly.

Accordingly, the followings are some of the objects, features, and advantages of the present invention.

It is an object of the present invention to provide a stir-frying apparatus for use to prepare tasteful and healthy stir-fried foods and to combine the benefits of frying, roasting, baking, etc. to achieve more efficient heating of foods.

It is another object of the present invention to provide a stir-frying apparatus that prepares foods faster, thereby saving users' time in preparing foods, and that is automatic for stir-frying to reduce the labor chore in preparing foods.

It is a further more object of the present invention to provide a stir-frying apparatus that is people and home environment friendly.

It is a feature of the present invention that this stir-frying apparatus has a bottom heating device and an overhead-heating device to execute a “3D” heating effect on foods, such that the required cooking time is significantly reduced and the food quality is enhanced.

It is another feature of the present invention that this stir-frying apparatus has a stirring blade rotatably and removably installed on the central bottom of a container for stirring foods. The blade sweeps across food pieces in an intermittent operation, in which it dwells for a predetermined interval of time near the end of each sweeping cycle and then automatically begins another cycle of operation. This intermittent operation affords relief from constant stirring of food pieces at a higher speed, thereby favoring foods of great texture and looking.

It is a further more feature of the present invention that this stir-frying apparatus has a forced venting system including a blowing device to force fresh air into the stir-frying apparatus for the moisture removal from therein-side and a venting device for removing the oil vapor content in the grease-laden air generated during a frying process before the air is exhausted into the room.

It is an advantage of the present invention that this stir-frying apparatus is virtually hand-free for stir-frying foods.

It is another advantage of the present invention that this stir-frying apparatus is oil splashing free and cooking fume free, such that it is people and home environment friendly.

It is a further more advantage of the present invention that this stir-frying apparatus reduces required cooking time and prepares high quality and healthy foods.

Further more features and advantages of the present invention will be readily appreciated, as the same becomes better understood after reading the subsequent description when considered in connection with the accompanying drawings.

### BRIEF DESCRIPTION OF DRAWINGS

FIG. 1 illustrates a cross-sectional view of an embodiment of the present invention, stir-frying apparatus 100.

FIG. 2 illustrates a cross-sectional view of stir-frying apparatus 100, taken along line A-A of FIG. 1.

FIG. 3 illustrates a top view of stir-frying apparatus 100.

FIG. 4 illustrates a cross-sectional view of stir-frying apparatus 100, taken along line A-A of FIG. 3, indicating blowing device 202.

FIG. 5 illustrates a cross-sectional view of stir-frying apparatus 100, taken along line B-B of FIG. 3, indicating safety switch 254.

FIG. 6 illustrates an exploded cross-sectional view of stirring blade 136.

FIG. 7 illustrates an exploded cross-sectional view of seal device 144.

FIG. 8 illustrates a cross-sectional view of one-way valve 218 of FIG. 4.

FIG. 9 illustrates a blocked diagram of control circuit 162 for stir-frying apparatus 100.

FIG. 10 illustrates a schematic diagram of control circuit 50 for providing an intermittent operation of blade sweeping for stir-frying apparatus 100.

FIG. 11 illustrates a schematic diagram of control circuit 70 for providing an intermittent venting operation of blowing device 202 for stir-frying apparatus 100.

FIG. 12 illustrates a perspective view of perforated basket 188 to be used with stir-frying apparatus 100 for deep frying foods.

FIG. 13 illustrates covering mechanism 190, indicating basket 188, which is in use for deep-frying foods.

FIG. 14 illustrates covering mechanism 190, when basket 188 is not in use for deep-frying foods.

### DETAILED DESCRIPTION

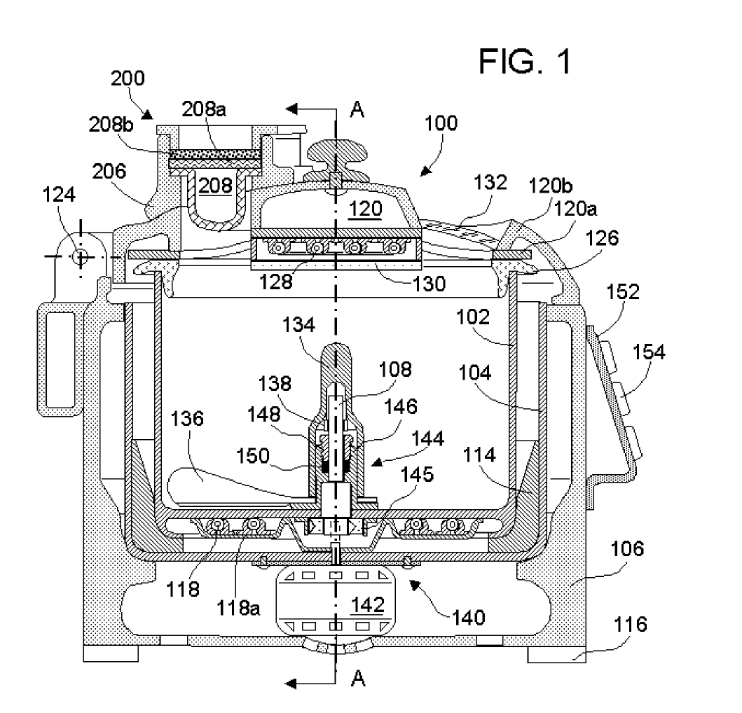

Reference is made to FIGS. 1-5, which illustrate an embodiment of the present invention, a stir-frying apparatus 100.

Reference is made to FIG. 1, which illustrates a cross-sectional view of apparatus 100.

Container 102, having an open top and a central bottom aperture, is provided for holding foods. Container 102 is installed inside an outer container 104, which is installed inside a housing 106. The central bottom aperture is provided to allow a drive shaft 108 to thread therethrough. Container 102 is, preferably, coated with a non-stick material.

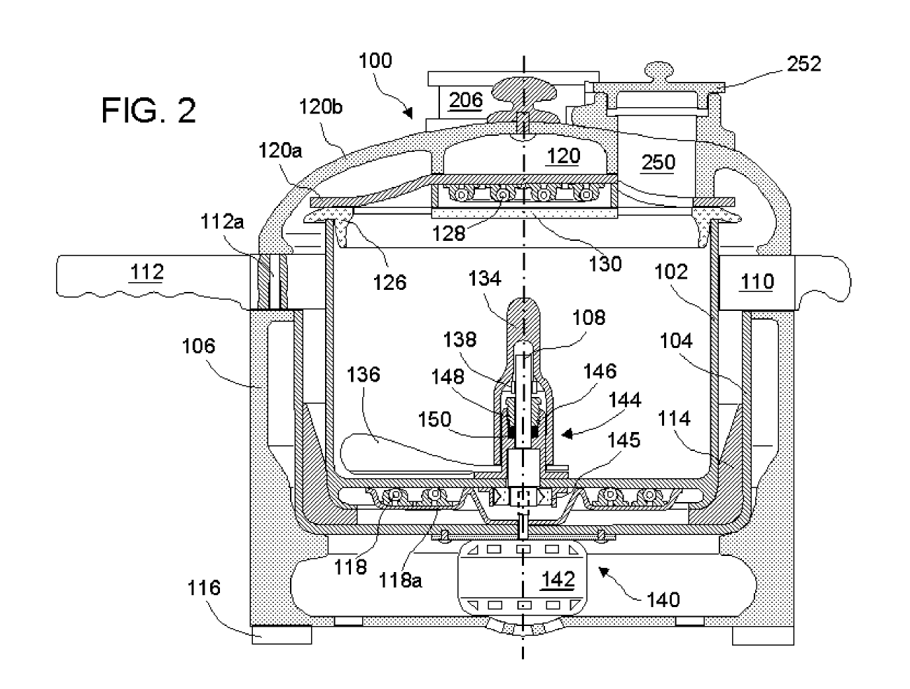

As shown in FIG. 2, which illustrates a cross-sectional view of apparatus 100, taken along line A-A of FIG. 1, a lift handle 110 is installed on one side of container 102, at an upper position. Handle 110 extends from container 102 to outside apparatus 100 through a recession on the upper edge of container 104 and a corresponding recession on the upper edge of housing 106. A grasp handle 112 is in-stalled on the other side of container 102, at an upper position. Handle 112 extends from container 102 to outside apparatus 100 through corresponding recessions on the upper edges of container 104 and housing 106. Handle 112 is lockably hinged, via hinge 112a, at a position close to container 102, such that handle 112 can be folded down or sideways to save some space when apparatus 100 is in a packed state.

A spacing element 114, installed in between containers 102 and 104, is provided for positioning and holding container 102 inside container 104.

A housing support 116, installed on the outside bottom of housing 106, is provided for furnishing a bottom support for apparatus 100, such that apparatus 100 is adapted to stand on a flat surface, e.g., a kitchen counter top.

A bottom-heating device 118, installed on a bracket 118a in between containers 102 and 104, around the central bottom thereof, is provided for heating foods disposed inside container 102. Heating device 118 is in a heat-transferable condition, e.g., in physical contact or radiation, with the bottom of container 102, such that when heating device 118 heats up upon connection with an electricity source, foods therein will also heat up. Heating device 118 can be electrical resistance type heaters or many other types, such as high-intensity infrared lamps or magnetic heating devices, as known to those skilled in the art and suggested by this invention disclosure.

Reference is made to FIG. 1, again. A lid 120, having an inner lid 120a and an outer lid 120b, is provided for covering on top of container 102 for closing up the open top thereof. Lid 120a is installed on lid 120b, which is hingedly installed on housing 106 via hinges 124. A seal element 126, installed on lid 120a, is provided for sealing in between lid 120 and container 102.

An overhead-heating device 128, installed on lid 120a, is provided for heating foods disposed inside container 102 from above. Heating device 128 is preferably in a radiation heat-transferable condition with foods, such that when heating device 128 heats up upon connection with an electricity source, foods therein will also heat up. Heating device 128 can be electrical resistance type heaters or many other types, such as high-intensity infrared lamps, as known to those skilled in the art and suggested by this invention disclosure. A covering piece 130, made of an infrared transparent material, is provided to protect heating device 128 against liquid splattering.

An observation window 132, made of a transparent material, is installed on lid 120 for observing frying processes therethrough by users.

Also illustrated in FIG. 1 is a venting device 200. Venting device 200, installed on lid 120, is provided for exhausting cooking fumes. Detailed discussion about venting device 200 shall be provided later on, when a forced venting system is disclosed.

A coupling device 134 is provided for coupling drive shaft 108 and a stirring blade 136 for transferring rotation power. The lower portion of coupling device 136 generally forms a cylindrical configuration or any other suitable configurations and is engaged with blade 136. A coupling element 138 on coupling device 134 is provided for lockably receiving shaft 108.

Blade 136, rotatably and removably installed inside container 102 on the central bottom thereof, is provided for stirring foods. The design of blade 136 can be substantially different, as known to those skilled in the art. The front portion of blade 136 is close to the bottom of container 102 with a small-predetermined clearance for better scooping up food pieces, as shown in FIG. 6, which illustrates a cross-sectional view of blade 136. The rear portion of blade 136 extends gradually upward and serves for lifting up/turning over food pieces. The clearance between the front portion of blade 136 and the bottom of container 102 is minimized for ideal performance.

The speed, at which blade 136 sweeps across food pieces, is important. For too low speeds, blade 136 cannot scoop up food pieces and therefore food pieces cannot be agitated adequately to achieve the desired effect of homogeneous heating. Co-rotation of food pieces with blade 136, as blade 136 rotates, is another important issue needs to be solved. Therefore, a higher speed is desirable for better performance of scooping up food pieces. However, for continuous operation of blade sweeping, when the speed is high, food pieces are agitated too much, for too long time, such that the texture of food pieces could be damaged.

To solve this dilemma, an intermittent operation of blade sweeping is proposed in this invention disclosure. In this intermittent operation, blade 136 dwells for a predetermined interval of time after one or two rounds of sweeping, referred to as one stirring cycle, and then automatically begins another cycle of operation. This intermittent operation affords relief from constant stirring of food pieces at a higher speed, prolongs the utility life of blade 136 and a power-drive assembly 140, and saves some energy required for driving blade 136, as compared with a continuous operation. This intermittent operation also favors foods of great texture because during the predetermined dwell period, the food pieces have adequate time to be heated; which, in turns, favors foods of great looking. A computer control method and an electronic control circuit for achieving this intermittent operation shall be disclosed later on, when the control portion of apparatus 100 is discussed.

Power-drive assembly 140 includes drive shaft 108 and a drive motor 142.

Motor 142 is installed on the outside bottom of outer container 104. The motor shaft of motor 142 threads through a central aperture on the bottom of container 104 and is coupled with drive shaft 108 through a proper coupling mechanism.

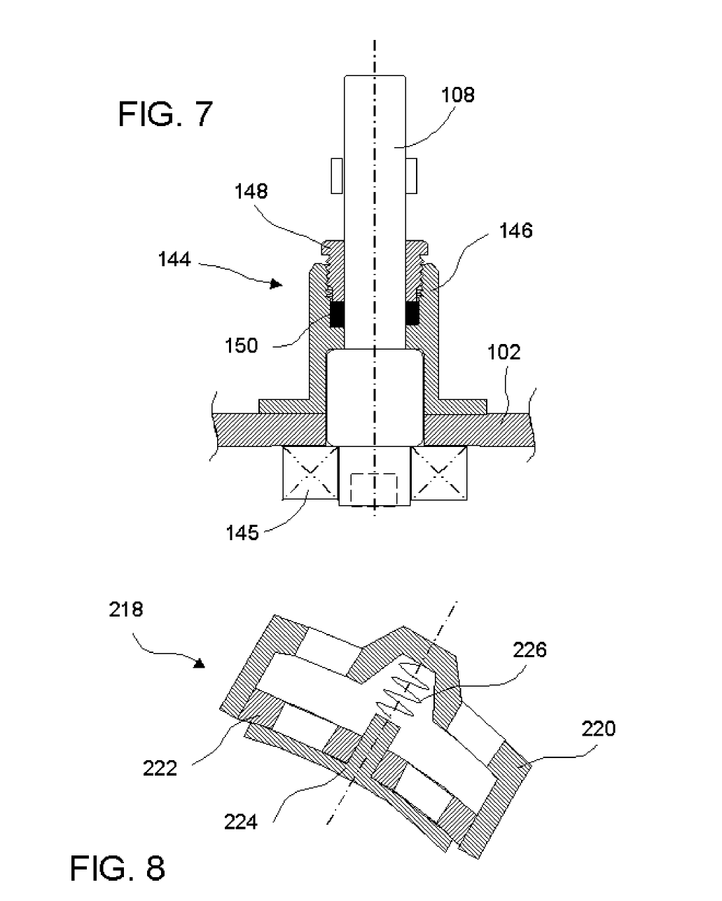

Drive shaft 108 is operationally coupled with motor 142, directly for a low-speed motor or via some gears or belt-pulley devices for a high-speed motor. The upper portion of drive shaft 108 is engaged with coupling device 134 via coupling element 138. Drive shaft 108 is installed on container 104 via a bearing element 145, which is better illustrated in FIG. 7.

A seal devicel44 is provided for sealing between shaft 108 and container 102, as shown in FIG. 7, which illustrates a cross-sectional view of seal 144. Seal 144 comprises a seal flange 146, a gland nut 148, and a compression packing 150.

Flange 146 is co-axial to shaft 108. The first end of flange 146 is sealingly installed on the inside surface of the central bottom of container 102. The second end of flange 146 emanates upwards to a predetermined height above the bottom of container 102. Gland nut 148 is engaged with the second end of flange 146 by means of screw. Packing 150 creates a seal by being squeezed between the throat of the stuffing box formed by flange 146 and gland nut 148. The squeeze force pushes the material of packing 150 against the throat of the box and rotating shaft 108.

When leakage occurs, gland nut 148 is tightened further.

This is a typical application of compression packings for low speed rotating shafts, such as shaft 108.

Materials are extremely important when selecting the proper packing for an application. Metallic packings are used in high-temperature applications. Shafts for copper and aluminum packings must be hardened to 500 Brinell hardness number (Bhn). Copper and aluminum packings can handle 538° C. (1000° F.) application temperature.

Seal 144 can, alternatively, take many other forms, such as bushing and labyrinth seals, or combinations of multiple forms for ideal performance, as known to those skilled in the art and suggested by this invention disclosure.

There is an important advantage of installing seal 144 inside container 102. For most applications, seal 144 is disposed higher than hot liquids, such that the sealing surface is not immersed in hot liquids. Therefore, the requirement on seal 144 is significantly reduced. In addition, shaft 108 is much better supported at a higher position. In operation, the lower portion of coupling device 134 is routed over seal 144.

As shown in FIG. 1, venting device 200 includes a venting conduit 206 and a venting filter 208. The first end of venting conduit 206 is mounted on lid 120. There is an opening on lid 120 inline with venting conduit 206 for allowing cooking fumes to be forced out therethrough. Venting conduit 206 also serves as a bracket for holding venting filter 208. Venting filter 208 is removably engaged with venting conduit 206. Venting filter 208 further includes a disposable paper or fabric filter 208a and/or a disposable activated charcoal filter 208b, together, forming an integrated multi-stage filtering system.

Venting filter 208 is provided to trap the grease impurities in the grease-laden air forced out from inside apparatus 100. Venting filter 208 is, preferably, made of one or multiple layers of metal meshes, such as aluminum ones. Metal meshes have different sizes of meshes and overlap each other. When cooking fumes pass therethrough, the oil particles will be trapped thereon. Filters 208a and 208b are provided to further remove the remaining oil vapor and chemical contents in cooking fumes and for the removal of cooking fume odors before the air is exhausted into the room.

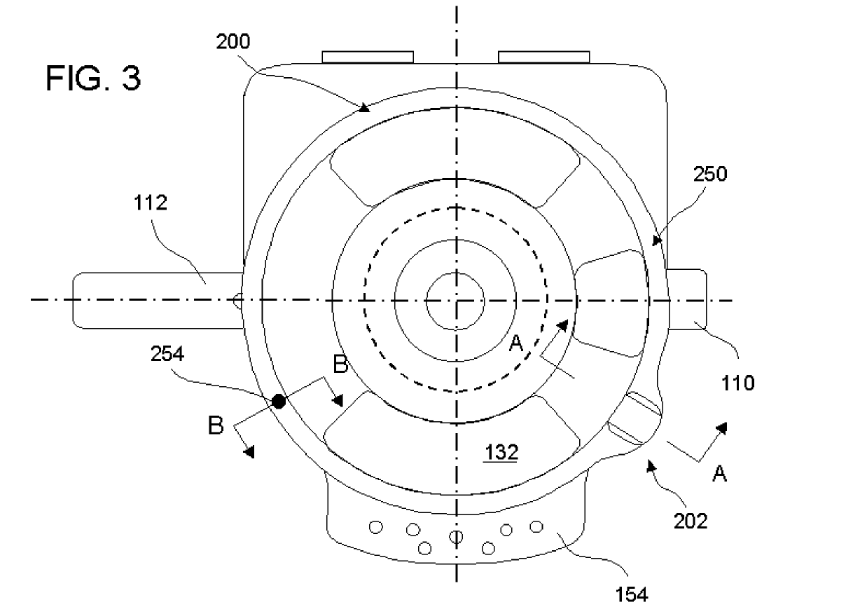

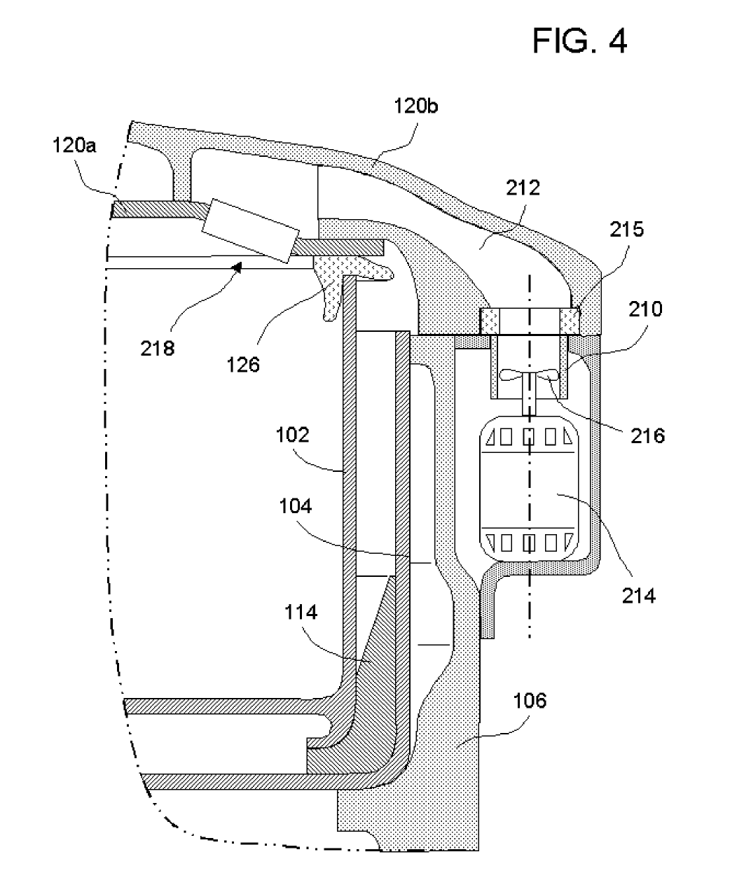

FIGS. 3 and 4 illustrate a blowing device 202. FIG. 3 illustrates a top view of apparatus 100, indicating the layout of various parts/devices on lid 120, and FIG. 4 illustrates a cross-sectional view of apparatus 100, taken along line A-A of FIG. 3, indicating blowing device 202.

A blowing motor 214 is provided for powering a fan 216. Fan 216 is connected to motor 214 on the shaft and inserted inside an in-take conduit 210. A conduit 212, disposed on lid 120, is in communication with conduit 210 and leads to a one-way valve 218. A seal element 215 is provided to seal the connection interface around conduits 210 and 212, when lid 120 is at a closing working position.

As shown in FIG. 8, which illustrates an exploded cross-sectional view of valve 218 of FIG. 4. Valve 218 includes a valve housing 220, a valve body 222, a covering piece 224, and a biasing spring 226. There are apertures on valve housing 220 for allowing air to pass therethrough. Valve body 222 is engaged with the open end of valve housing 220. There are apertures on valve body 222 for allowing air to pass therethrough. Covering piece 224 covers on valve body 222 for closing and opening valve 218. There is a central protrusion on covering piece 224. The central protrusion is slidably inserted into a central aperture on valve body 222, such that the protrusion can slide along the central aperture for a predetermined distance. Spring 226 is attached between the protruding end of the protrusion and valve housing 220, such that spring 226 is biased in slight tension, thereby pulling covering piece 224 toward/against valve body 222 for closing up valve 218.

When blowing device 202 is in working condition, the air pressure generated by fan 216 forces covering piece 224 to slide away from valve body 222, such that valve 218 is in opening state for allowing air to pass therethrough. Valve 218 is provided for preventing cooking fumes inside apparatus 100 from escaping through blowing device 202 while blowing device 202 is temporarily not in working condition.

Those skilled in the art will appreciate in view of this invention disclosure that many other suitable valve designs are readily applicable for this application of the present invention.

Venting device 200 and blowing device 202 can be alternatively installed on apparatus 100 at many other proper positions. For example, venting device 200 can be alternatively installed on an upper portion of container 102 and blowing device 202 can be alternatively mounted on lid 120.

These variations are, therefore, covered by this invention disclosure.

Venting device 200 is provided for cooking fume treatment and blowing device 202 is provided for forcing moisture content out of apparatus 100, such that apparatus 100 can fry foods of great taste, great texture, and great looking. However, there is some heating energy loss associated with using blowing device 202. Therefore, the use of blowing device 202 should be in a controlled manner.

Stronger blowing favors better inside airflow for better facilitating moisture removal. However, Continuous strong blowing will cause excessive heating energy loss. To solve this dilemma, an intermittent venting operation is proposed in this invention disclosure. In this intermittent venting operation, fan 216 is de-energized for a predetermined interval of time near the end of a blowing cycle, e.g., of 10 seconds, and then automatically begins another cycle of operation. An electronic control circuit for achieving this intermittent operation shall be disclosed later on, when the control portion of apparatus 100 is discussed.

Immediately after a frying process is satisfactorily accomplished, the food is still hot and there is still residual cooking fume residing inside apparatus 100. Blowing device 202 can be used to bring in fresh air to cool the food down fast to a predetermined temperature and, at the same time, to purge the residual cooking fumes out through venting device 200. This process greatly favors safety of food handling, home environment protection, and foods of great texture and looking, especially for fried and roasted foods.

The above-discussed forced venting system is good for frying, roasting, baking, etc. For stir-frying, especially for frying vegetables, it favors foods of great looking. It is a well-known fact that when fried using a conventional frying pan with a lid covering on top thereof, green vegetables tend to become yellowish, soggy, and limp.

Reference is made to FIG. 2. An ingredient adding conduit 250, installed on lid 120, is provided for use to add ingredients, such as salt, pepper, soy sauce, etc., during a frying process. A cap 252 is provided for closing up conduit 250 when conduit 250 is not in use.

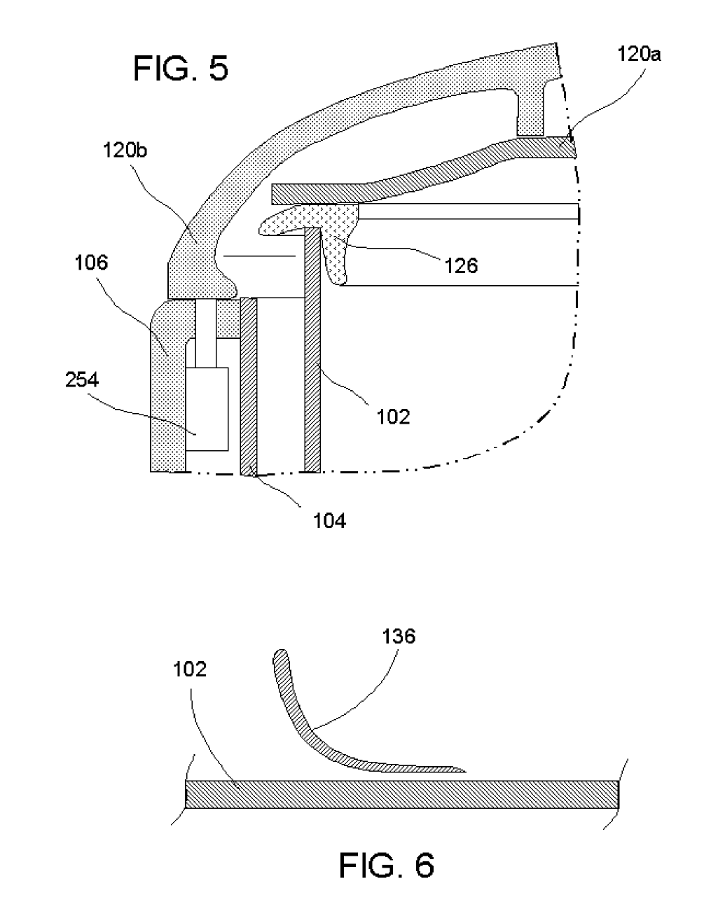

Reference is made to FIG. 5, which illustrates a cross-sectional view of apparatus 100, taken along line B-B in FIG. 3. A safety switch 254 is provided on the upper edge of housing 106. When lid 120 is lifted up, switch 254 shall shut down the power to motors 142 and 214 and heating device 128 for safety considerations.

Reference is made to FIG. 1, again. A control housing 152 is provided for housing electrical control devices or elements and supporting a control panel 154. Control housing 152 is installed on the sidewall of housing 106. Control panel 154 is provided for supporting elements, like switches, indicators, adjusting knobs, beepers, LCD, and so on.

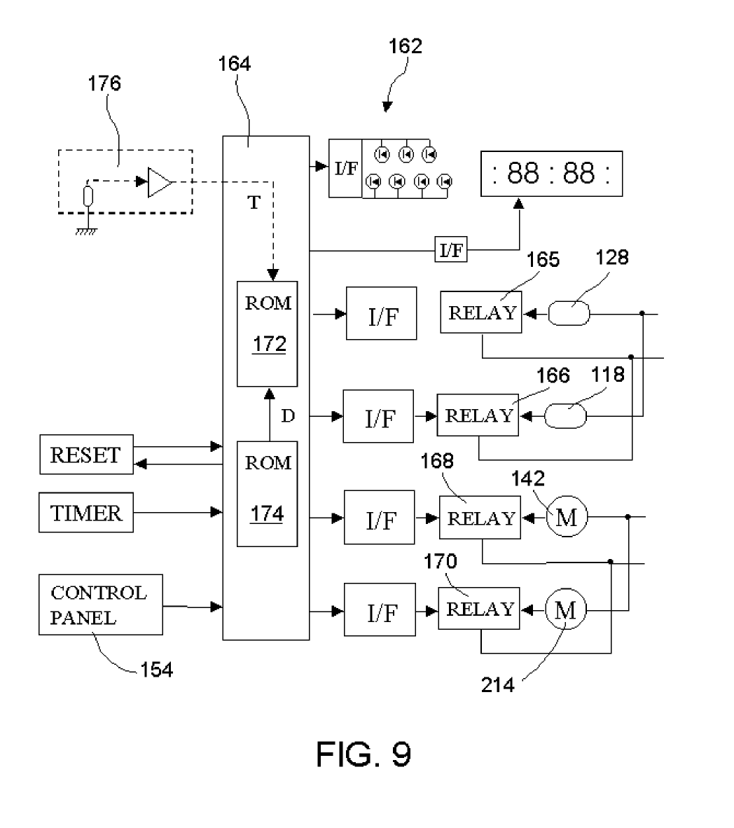

FIG. 9 illustrates a block construction diagram of a control circuit 162 for controlling various functions of apparatus 100, such as temperature for frying foods, motor speeds for rotating blade 136, and the speed at which blowing motor 214 is rotating. Circuit 162 comprises a microcomputer 164, which controls various functions of apparatus 100, a relay 165, which activates heating device 128, a relay 166, which activates heating device 118, a relay 168, which activates motor 142, and a relay 170, which activates motor 214.

Microcomputer 164 is provided with ROM and RAM for data memory, and further provided with I/O ports A/D converters as interfaces. The aforementioned ROM″s comprises a ROM 172 containing control programs related to the performance of frying processes and a ROM 174, which memorizes referenced data.

A temperature sensor 176, disposed at a proper position, is provided for measuring the temperature inside container 102, which is taken by microcomputer 164, as an input variable to be controlled. When the temperature is above the user's desired one, the electrical power to heating devices 118 and 128 will be shut down by relays 165 and 166 to better meet the user's desired frying requirement and to save energy.

Computer 164 can be such programmed that relay 168 activates motor 142 intermittently with a bias toward a longer dwell after each stirring cycle of one or two rounds of rotation. In the same manner, an intermittent venting operation can be programmed with relay 170 activating motor 214 intermittently.

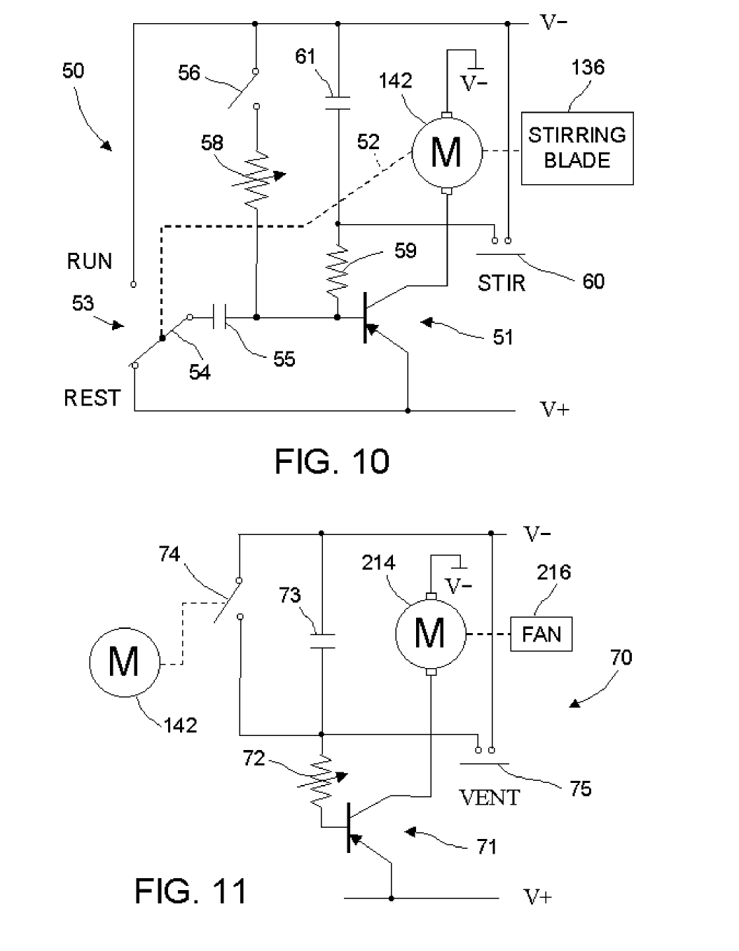

Reference is made to FIG. 10, which illustrates a schematic diagram of a control circuit 50 for providing the intermittent operation of blade sweeping for apparatus 100.

As shown in FIG. 10, drive motor 142 is operationally coupled with blade 136 for providing rotation power. Motor 142 has a first terminal, which is connected to V−, the negative pole of a power source, and a second terminal, which is connected to the collector terminal of a PNP bipolar transistor 51. The emitter terminal of transistor 51 is connected to V+, the positive pole of a power source. Associated with motor 142 is a linkage mechanism 52, which cooperates with a single pole, double throw switch 53, such that the shaft angle of motor 142 controls the switching position. Switch 53 includes a single pole 54, which is connected to the first end of a capacitor 55. Pole 54 may be switched alternately between two throw positions as represented by RUN and REST. The reference RUN refers generally to the position of blade 136 when in sweeping. On the other hand, the reference REST refers generally to the position of blade 136 when in dwelling. The RUN position represents substantially a large portion of a whole round of rotation angle of the motor shaft, e.g., over 80%. The RUN position is associated with V− and the REST position is associated with V+.

A main switch 56 is provided for activating and deactivating the intermittent operation provided by circuit 50. Switch 56 has a first terminal connected to V− and a second terminal connected to the first end of a variable resistor 58.

The second end of capacitor 55 is connected to the second end of resistor 58. Also connected to the second end of capacitor 55 are the base of transistor 51 and the second end of a resistor 59. The first end of resistor 59 is connected to the first terminal of a STIR switch 60, which can activate a STIR feature, a manually activated continuous operation. The second terminal of switch 60 is associated with V−. The first end of resistor 59 is also connected to the second end of a capacitor 61. The first end of capacitor 61 is connected to V−.

Switch 60 is a push button switch for activating the STIR feature. When switch 60 is pushed, the two terminals are connected, which causes the connection of the first end of resistor 59 to V− and, at the same time, causes capacitor 61 to be short-circuited.

With switch 56 in the activated position and switch 60 in the deactivated position, circuit 50 will operate blade 136 intermittently with a variable dwell period at the end of each sweeping cycle. This intermittent operation is achieved through the circuit of transistor 51, switch 53, capacitor 55, and resistor 58.

Now, to start with, suppose motor 142 has not been operating because switch 56 has been in the deactivated position. Also suppose switch 53 has been in the REST position, and thus capacitor 55 has been discharged.

When switch 56 is activated, the potential at the second end of resistor 58 will be lowered to cause transistor 51 to switch to conductive state, thereby energizing motor 142. As soon as motor 142 begins to rotate, switch 53 will be thrown to the RUN position, which causes the first end of capacitor 55 to be connected to V−. Capacitor 55 will then begin to charge so as to make the second end of capacitor 55 positive with respect to the first end thereof. Sufficient base current will be provided through the base of transistor 51 to cause transistor 51 to remain conductive even after capacitor 55 becomes fully charged, thereby causing motor 142 to continue to rotate throughout a full rotation cycle until switch 53 is cycled back to the REST position. When switch 53 cycles back to the REST position, the first end of capacitor is then connected to V+ and capacitor 55 begins to discharge through resistor 58 until the potential at the second end of resistor 58 becomes sufficiently negative relative to V+. During this period of time, transistor 51 is switched to and remains in non-conductive state, thereby stopping motor 142 for a predetermined interval of time. And then, sufficient base current flow resumes, causing transistor 51 to become conductive again, and a new cycle starts.

The length of the dwell interval is determined by the time required for capacitor 55 to discharge. Proper selection of capacitor 55 and resistor 58 will provide desirable dwell intervals.

With resistor 59 and capacitor 61 in addition, a manually activated continuous blade-sweeping feature can be achieved in addition to and in combination with the controllable variable dwell feature. This performance feature is achieved regardless of whether switch 56 is in the activated position or not when switch 60 is pushed. Moreover, it will be seen if switch 56 is in the activated position when switch 60 is pressed, there will be an immediate override of the intermittent operation. The continuous operation will keep on going without any dwell for a predetermined number of cycles, for example, one or two, after switch 60 is released, before the intermittent operation is resumed. If switch 56 is in the deactivated position when switch 60 is pressed, motor 142 will immediately start to rotate. After switch 60 is released, motor 142 will continue for a predetermined number of continuous sweeping cycles and then stops.

When switch 60 is pressed, the first end of resistor 59 is connected to V−. This allows sufficient current to flow through the base of transistor 51 to switch transistor 51 to conductive state, thereby causing motor 142 to start and operate. By proper selection of the value of resistor 59, this mode of operation will occur regardless of the positions of switches 53 and 56, so long as switch 60 is depressed.

At the same time, pressing switch 60 causes capacitor 61 to be short-circuited such that any charge stored therein is discharged through the short circuit to V−. When switch 60 is released, the current flowing out of the base of transistor 51 will continue through discharged capacitor 61 until capacitor 61 recharges. As a result, transistor 51 will continue in conductive state and motor 142 will continue to operate at the normal speed. Transistor 51 will continue in conductive state for a predetermined period of time based on the time constant provided by resistor 59 and capacitor 61, which are preferably selected to provide one or two continuous sweeping cycles without any dwell after switch 60 is released.

One important point worth mentioning is that if power-drive assembly 140 has a rotation reduction mechanism, linkage 52 should be set between the output shaft of assembly 140 and switch 53, instead of between motor 142 and switch 53.

If multiple rounds of sweeping are desired for a stirring cycle, before one dwell period, e.g., two rounds of sweeping before one dwell period, a pair of gears, or some other mechanisms, should be provided, with the smaller one in-stalled on the output shaft and the larger one cooperating with switch 53. The transfer-ratio should be 1:2.

The intermittent operation of blade sweeping can be alternatively achieved using a mechanically controlled timer, e.g., a spring-driven timer (not shown). Numerous discrete contact poles can be provided on a circular plate, such that when a needle is rotating around a central shaft, the needle engages with each contact pole in sequence. The angle range of each pole represents a stirring cycle. At the end of each stirring cycle, there is a predetermined dwell period, which is represented by the angle range in between two adjacent poles.

Reference is made to FIG. 11, which illustrates a schematic diagram of a control circuit 70 for providing the intermittent venting operation for apparatus 100.

As shown in FIG. 11, blowing motor 214 is operationally coupled with fan 216 for forcing fresh air into apparatus 100. Motor 214 has a first terminal, which is connected to V−, and a second terminal, which is connected to the collector terminal of a PNP bipolar transistor 71. The emitter terminal of transistor 71 is connected to V+. The base of transistor 71 is connected to the second end of a variable resistor 72. The first end of resistor 72 is connected to the second end of a capacitor 73. The first end of capacitor 73 is connected to V−.

Also connected to the first end of resistor 72 are the second terminal of a magnetically activated switch 74 and the first terminal of a VENT switch 75. The first terminal of switch 74 and the second terminal of switch 75 are connected to V−.

Switch 74 is provided for activating and deactivating the intermittent venting operation provided by circuit 70. Switch 74 communicates with motor 142, such that when motor 142 is in working state, switch 74 is activated and remains in activated condition until motor 142 ceases to work. Switch 75 is a push button switch, which is provided for activating a manually activated continuous venting feature.

When either switch 74 or switch 75 is activated, the first end of resistor 72 is connected to V− and, at the same time, capacitor 73 is short circuited to V−.

With switch 74 in the activated position and switch 75 in the deactivated position, circuit 70 will operate fan 216 intermittently with a variable dwell period at the end of each venting cycle. This intermittent venting operation is achieved through the circuit of transistor 71, resistor 72, capacitor 73, and switch 74, which is conditioned by motor 142.

When motor 142 is in working state, switch 74 is activated, such that the first end of resistor 72 is connected to V−, and capacitor 73 is short circuited to V−. The potential at the second end of resistor 72 is lowered to cause transistor 71 to switch to conductive state, thereby energizing motor 214. As soon as motor 142 stops, switch 74 is deactivated. The current flow out of the base of transistor 71 will continue through discharged capacitor 73 until capacitor 73 recharges. As a result, transistor 71 will continue in conductive state and motor 214 continue to operate at the normal speed. Transistor 71 will continue in conductive state for a predetermined period of time based on the time constant provided by resistor 72 and capacitor 73, which are preferably selected to provide a multiple of a sweeping cycle of blade 136, e.g., five continuous blade sweeping cycles. Motor 214 then dwells for a predetermined interval of time until the next cycle of the intermittent operation of blade 136 starts, when motor 142 activates switch 74, again.

With switch 75 in addition, a manually activated continuous venting performance feature can be achieved in addition to and in combination with the controllable variable dwell feature. This performance feature is achieved regardless of whether switch 74 is in the activated position or not when switch 75 is pushed. Moreover, it will be seen if switch 74 is in the activated position when switch 75 is pressed, there will be an immediate override of the intermittent venting operation. The continuous operation will keep on going without any dwell for a predetermined interval of time after switch 75 is released, before the intermittent venting operation is resumed. If switch 74 is in the deactivated position when switch 75 is pressed, motor 214 will immediately start to rotate. After switch 75 is released, motor 214 will continue for a predetermined interval of time, and then stops.

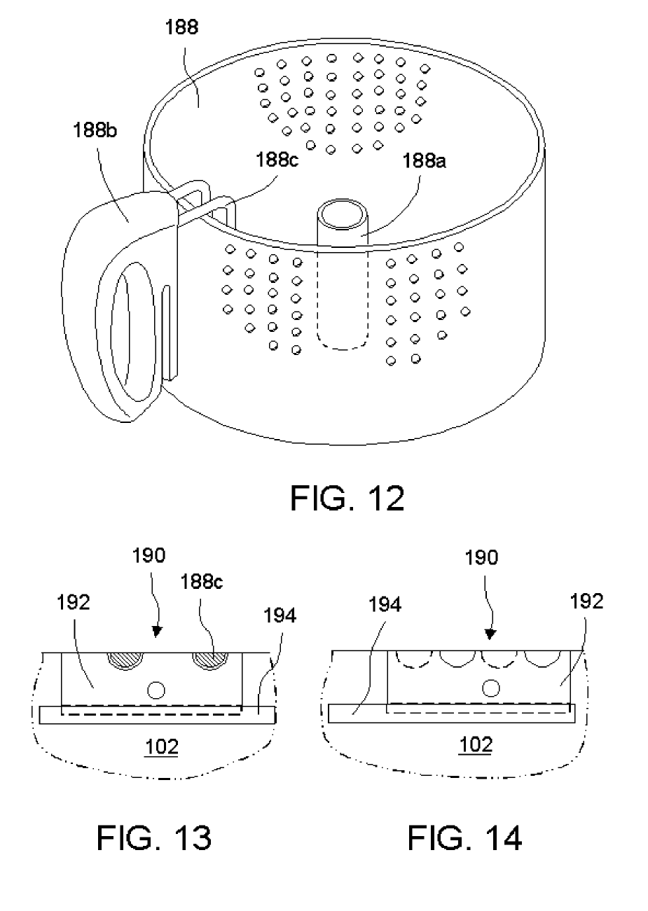

FIG. 12 illustrates a perspective view of a perforated basket 188 for use with apparatus 100. Basket 188, provided primarily for deep-frying foods, is preferably cylindrical in configuration and has an upstanding inner cylindrical wall 188a defining a central aperture and a basket handle 188b for handling basket 188.

Wall 188a is installed on the central bottom of basket 188, so as to emanate up toward the upper portion thereof, and removably receives seal 144 therethrough. Handle 188b is installed on the upper portion of basket 188. Some small recessions, disposed on the upper edge of containers 102 and 104 and housing 106, are provided to allow metal rods 188c connecting the main body of handle 188b and the main body of basket 188 to extend from inside to outside of apparatus 100.

When basket 188 is no longer desired, a suitable covering mechanism 190, which includes a covering piece 192 and a guide 194, as shown in FIGS. 13 and 14, is provided to close the recessions on the upper edge of container 102. FIG. 13 illustrates a working state when basket 188 is in use for deep-frying foods and FIG. 14 illustrates a working state when basket 188 is no longer in use. Guide 194 is installed on an upper portion of container 102 and covering piece 192 can slide along guide 194. There are recessions on the upper edge of covering piece 192. At a position, as shown in FIG. 13, the recessions on covering piece 192 are inline with the recessions on the upper edge of container 102, such that basket 188 can be used. While at another position, as shown in FIG. 14, covering piece 192 close up the recessions on the upper edge of container 102, when basket 188 is not in use, such that no cooking fumes pass therethrough.

In operation, a user: First, charges container 102 with some oil, and then preheats the oil to a predetermined temperature, preferably, halfway boiling. This step can be one step of a cooking program.

Second, charges container 102 with foods to be fried and some necessary ingredients.

Third, selects a temperature, a time duration, a stirring blade rotation speed, and a blowing motor speed, or a program for frying foods, and then pushes on a start button to activate a frying process.

The whole frying process is hand-free. The user does not have to be involved with the frying process until the frying is accomplished or the frying apparatus beeps to remind the user to add more ingredients.

For the embodiment discussed above, when the inner container is large, the stirring blade is consequently large, such that it may not be quite convenient to use or handle.

In order to solve this problem, for a frying apparatus having a large inner container, the lower portion of this inner container can be adapted to taper inward, such that the bottom of the container has a smaller diameter. Consequently, the stirring blade can be designed smaller.

Accordingly, readers will see that this stir-frying apparatus of the present invention can be used to prepare tasteful fried foods. There are a bottom heating device and an overhead heating device, together, forming a highly efficient heating system, such that foods are heated faster and more uniformly. Frying processes are executed in an automatic manner, thereby minimizing human involvement and chore in preparing foods. This frying apparatus is used with the lid fully covering on top of a container, thereby eliminating the possibility of grease splattering and the risk of oil burns to people. At the same time, the grease-laden air generated during frying processes is forced out through a venting device and filtered before being discharged into the room, thereby avoiding long-term hazards to the people and home environment.

The stirring blade sweeps across food pieces intermittently, such that the blade dwells for a predetermined dwell period starting near the end of each stirring cycle. This intermittent operation favors better agitation of food pieces and affords relief from constant stirring of foods at a higher speed.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

For examples, although this invention has been described in a form of home frying apparatuses, it can have potential business use, such as use in restaurants. Therefore, this invention can alternatively be described as food processing equipment. Although the forced venting system of this invention has been described in a form of blowing fresh air into the frying apparatus, it is understood that rearrangement of the motor, fan, and filters, such that, instead of blowing fresh air into the frying apparatus, the fan actually draws the moisture-laden and grease-laden air out of the frying apparatus, is perfectly inline with the spirit of the forced venting concept of this invention. Such rearrangement is, therefore, covered by the present invention.

Thus it is understood that the present disclosure of the preferred forms can be changed in the details of construction and in the combination and arrangement of parts without departing from the spirit and the scope of the invention as hereinafter claimed.

1. A stir-frying apparatus, said stir-frying apparatus comprising:
a container having an open top for holding foods;
a lid covering on top of said container for closing up said open top of said container;
a bottom heating device disposed underneath said container for heating foods disposed inside said container;
an over-head heating device disposed at an upper position of said stir-frying apparatus for heating foods disposed inside said container;
a stirring device installed inside said container on the bottom for stirring foods disposed inside said container; and
a power-drive assembly operationally coupled with said stirring device for driving said stirring device through repeating stirring cycles.

2. A stir-frying apparatus as defined in claim 1, wherein said container has a central bottom shaft aperture, wherein said power-drive assembly is disposed under said container and includes an drive shaft threaded through said central bottom shaft aperture, and said stir-frying apparatus further including a seal device for sealing between the bottom of said container and said drive shaft.

3. A stir-frying apparatus as defined in claim 1, said stir-frying apparatus further including a housing for heat insulation of said stir-frying apparatus and for adapting said stir-frying apparatus to stand on a flat surface, wherein said lid is hingedly installed at an upper position of said housing, and wherein said overhead heating device is installed on said lid.

4. A stir-frying apparatus as defined in claim 1, wherein said container includes a grasp handle hingedly installed at an upper position of said container.

5. A stir-frying apparatus as defined in claim 2, said stir-frying apparatus further including a coupling device for operationally coupling said power-drive assembly and said stirring device and wherein said coupling device includes a coupling element for releasably receiving said drive shaft.

6. A stir-frying apparatus as defined in claim 2, wherein said seal device is installed inside said container, so as to emanate upwards to a predetermined height, such that for most applications of said stir-frying apparatus said seal device is above hot liquids, whereby the requirement on said seal device is significantly reduced.

7. A stir-frying apparatus as defined in claim 1, wherein said over-head heating device is installed on said lid.

8. A stir-frying apparatus as defined in claim 1, wherein said over-head heating device includes an electrical resistance heat-generating element.

9. A stir-frying apparatus as defined in claim 1, wherein said over-head heating device includes a high intensity infrared heat-generating element.

10. A stir-frying apparatus as defined in claim 1, wherein said over-head heating device includes a infrared-transparent covering piece for protecting said over-head heating device against liquid splattering.

11. A stir-frying apparatus as defined in claim 1, said stir-frying apparatus further including a control device for automatically de-energizing said power-drive assembly near the end of each stirring cycle for a predetermined dwell period.

12. A stir-frying apparatus as defined in claim 11, wherein said control device includes a switch circuit for de-energizing and energizing said power-drive assembly and a timing circuit to determine said predetermined dwell period.

13. A stir-frying apparatus as defined in claim 1, said stir-frying apparatus further including a blowing device for forcing fresh air into said stir-frying apparatus during a frying process, thereby facilitating moisture removal from inside said stir-frying apparatus.

14. A stir-frying apparatus as defined in claim 13, wherein said blowing device includes fan means, a blowing motor for driving said fan means, and a one-way valve for preventing cooking fumes from escaping therethrough.

15. A stir-frying apparatus as defined in claim 13, said stir-frying apparatus further including control means, said control means dividing the blowing operation of said blowing device into repeating blowing cycles of predetermined length and automatically de-energizing said blowing device near the end of each blowing cycle for a predetermined period of time.

16. A stir-frying apparatus as defined in claim 1, wherein said stir-frying apparatus further including a venting device for exhausting cooking fumes.

17. A stir-frying apparatus as defined in claim 16, wherein said venting device includes filter means for cooking fume treatment.

18. A stir-frying apparatus as defined in claim 1, said stir-frying apparatus further including an ingredient adding conduit disposed on said lid for use of adding ingredients during a frying process and wherein said ingredient adding conduit includes a cap for closing said ingredient adding conduit when said ingredient adding conduit is not in use.

19. A stir-frying apparatus as defined in claim 1, said stir-frying apparatus further including a basket having an open top and a central aperture on the bottom thereof for use to deep-fry foods.

20. A stir-frying apparatus, said stir-frying apparatus comprising:
a container having an open top for holding foods;
a lid covering on top of said container for closing up said open top of said container;
a bottom heating device disposed underneath said container for heating foods disposed inside said container;
an over-head heating device disposed at an upper position of said stir-frying apparatus for heating foods disposed inside said container;
a stirring device installed inside said container for stirring foods disposed inside said container;
a power-drive assembly operationally coupled with said stirring device for driving said stirring device through repeating stirring cycles;
a blowing device for forcing fresh air into said stir-frying apparatus during a frying process, thereby facilitating moisture removal from inside said stir-frying apparatus; and
a venting device for exhausting and treating cooking fumes.

21. A stir-frying apparatus as defined in claim 20, said stir-frying apparatus further including a control device for automatically de-energizing said power-drive assembly near the end of each stirring cycle for a predetermined dwell period.

22. A stir-frying apparatus as defined in claim 20, said stir-frying apparatus further including an ingredient adding conduit disposed on said lid for use of adding ingredients during a frying process and wherein said ingredient adding conduit includes a cap for closing said ingredient adding conduit when said ingredient adding conduit is not in use.

23. A stir-frying apparatus as defined in claim 20, wherein said container includes a grasp handle hingedly installed at an upper position of said container.

24. A stir-frying apparatus as defined in claim 20, said stir-frying apparatus further including a housing for heat insulation of said stir-frying apparatus and for adapting said stir-frying apparatus to stand on a flat surface, wherein said lid is hingedly installed on said housing, and wherein said overhead heating device is installed on said lid.

25. A stir-frying apparatus as defined in claim 20, wherein said container has a central bottom shaft aperture, wherein said power-drive assembly is disposed under said container and includes an drive shaft threaded through said central bottom shaft aperture, and said stir-frying apparatus further including a seal device for sealing between the bottom of said container and said drive shaft.
